(19) United States
(12) Patent Application Publication
(10) Pub. No.: US 2024/0059618 A1
(43) Pub. Date: Feb. 22, 2024

(54) METHOD OF MANUFACTURING LIGHTWEIGHT THERMAL INSULATING CELLULAR CEMENT-BASED MATERIALS

(71) Applicant: Nano and Advanced Materials Institute Limited, Hong Kong (HK)

(72) Inventors: Bin XIAO, Hong Kong (HK); Calvin Chun Long CHEUNG, Hong Kong (HK); Mingran LIU, Hong Kong (HK)

(21) Appl. No.: 18/453,311

(22) Filed: Aug. 22, 2023

Related U.S. Application Data
(60) Provisional application No. 63/399,724, filed on Aug. 22, 2022.

(51) Int. Cl. C04B 38/02; C04B 7/32; C04B 11/26; C04B 41/53

(52) U.S. Cl. CPC C04B 38/02; C04B 7/323; C04B 11/26; C04B 41/53; C04B 2201/20; C04B 2201/32; C04B 2111/28

(57) ABSTRACT

A method of manufacturing a lightweight thermal insulating cellular cement-based material and a lightweight thermal insulating cellular cement-based board made thereof are disclosed. A binder, an activator, and a blowing agent are mixed to obtain a mixture. The mixture is homogenized to form a cement slurry, which is poured into a mold afterwards. With the help of the activator and an increased temperature of the mold, the cement slurry in the mold will be activated and start foaming and curing to form a cellular cement-based material. The cellular structure is constructed by decomposition of the blowing agent to form a plurality of closed-cell bubbles, which are fixed in the cement slurry during the curing. After the formation, the mold is removed to obtain the cellular cement-based material. The material exhibits high integrity fire resistance and extraordinary insulation fire resistance.

### CROSS-REFERENCE TO RELATED APPLICATIONS

The present application claims priority from U.S. provisional patent application Ser. No. 63/399,724 filed Aug. 22, 2022, and the disclosure of which is incorporated herein by reference in its entirety.

### FIELD OF THE INVENTION

The invention relates to the technical field of composite materials. More particularly, it relates to lightweight thermal insulating cellular cement materials.

### BACKGROUND OF THE INVENTION

Home safety is a critical factor for home purchase or rental. The biggest disaster threat to families in the United States, and across the world, is fire. According to the U.S. Fire Administration (USFA), there are almost 365,000 reported residential fires in the U.S. every year. Similarly, in China, there were 252,000 fires reported to the fire services in 2020. House fires are undeniably life-threatening and pose a serious concern.

To ensure personal safety from fire, the most effective and fundamental approach is to identify and remove fire hazards. However, when a fire happens and is beyond control, the best response is to slow down the spread of fire, evacuate, and call for help. Ideally, houses built with thermal insulating and fireproof materials can contain and restrict fire spread of fire, providing household members with precious time to escape.

One of the most commonly-used construction materials is cement, known for its affordability, soundproofing and fire resistance. However, it has poor refractory properties. Normally, cement will burst or perforate under high heat, leading to house collapse during a fire. To protect household occupants, houses should be able to maintain their structures under high heat during a fire. By preventing house collapse, escape plans and rescue efforts can be conducted much more efficiently, particularly for multistory, multifamily dwellings. Tragically, many fatalities occur when houses cannot withstand the heat of a fire and subsequently collapse, trapping the residents inside.

Therefore, there is a need in the art for a low-cost thermal insulating construction material with strong refractory properties and fire resistance to maintain building structures without rupture or perforation under high heat. The present invention addresses this need.

### SUMMARY OF THE INVENTION

Based on the above limitations and needs, the present invention provides a method of manufacturing lightweight, thermally insulating cellular cement-based materials and a cement-based board made thereof.

It is an objective of the present invention to provide a method of manufacturing a lightweight thermal insulating cellular cement-based material and a lightweight thermal insulating cellular cement-based board.

In accordance with a first aspect, the present invention provides a method of manufacturing a lightweight thermal insulating cellular cement-based material. Firstly, an inactive binder, an inactive activator, and an inactive blowing agent are mixed to obtain a mixture. The mixture is then homogenized, resulting in the formation of a cement slurry. This cement slurry is subsequently poured into a mold. With the aid of the blowing agent and an increased mold temperature, the cement slurry inside the mold is activated and begins to foam and cure, leading to the formation of a cellular cement-based material. The cellular structure is constructed by the simultaneous decomposition of the blowing agent, forming a plurality of closed-cell bubbles, while the curing of the cement slurry solidifies the cellular structure. After the formation process, the mold is removed, and the cellular cement-based material is obtained.

In accordance with one embodiment of the present invention, the lightweight thermal insulating cellular cement-based material has a thermal conductivity less than 0.08 W/mK, a density ranging between 300 and 1200 kg/m³, a shrinkage smaller than 5% at 1200° C. and an integrity fire resistance rating for 4 hours and an insulation fire resistance rating for 4 hours.

In accordance with one embodiment of the present invention, the activator is water. In other embodiments, the blowing agent is selected from ammonium bicarbonate, sodium bicarbonate, hydrogen peroxide, C₄-C₇ aliphatic hydrocarbon, or any combination thereof.

In accordance with another embodiment of the present invention, the binder is selected from calcium aluminate cement, calcium sulfoaluminate cement, calcium sulfate cement, or any combination thereof.

In accordance with one embodiment of the present invention, the activator includes water, sodium hydroxide, potassium hydroxide, sodium silicate, potassium silicate, phosphoric acid, aluminium dihydrogen phosphate, or any combination thereof.

In accordance with one embodiment of the present invention, the mixture further comprises a filler. In some embodiments, the mixture further comprises a surfactant.

In accordance with one embodiment of the present invention, the method further comprising cutting, trimming or sanding the cement-based material into a specified shape, such as a block, a panel, a board or a sheet.

In accordance with another embodiment of the present invention, after the foaming and curing of the cement slurry, a thermal insulation mixture is further applied to the cellular cement-based material. Firstly, a thermal insulation mixture is prepared by mixing a coating binder, an acid source, a carbon source, a coating blowing agent and a thermal reflective agent. Subsequently, the thermal insulation mixture is applied to the cellular cement-based and cured to form a thermal insulation layer on top of it.

In accordance with one embodiment of the present invention, the coating binder is selected from epoxy resin, acrylic emulsion, silicone emulsion, silicone-acrylic emulsion, styrene-acrylic emulsion, polyvinyl acetate emulsion, vinyl acetate-ethylene emulsion, sodium silicate solution, or any combination thereof.

In accordance with another embodiment of the present invention, the acid source is selected from ammonium polyphosphate, ammonium dihydrogen phosphate, ammonium hydrogen phosphate, melamine phosphates, melamine polyphosphate, melamine pyrophosphate, guanyl urea phosphate, urea phosphate, ammonium tetraborate or any combination thereof. In some embodiments, the carbon source is selected from pentaerythritol, dipentaerythritol, polyols, carbohydrates, or any combination thereof. In other embodiments, the coating blowing agent is selected from melamine, dicyandiamide, urea, glycine, guanidine, melamine cyanurate, melamine phosphate, melamine pyrophosphate, melamine polyphosphate, or any combination thereof. In some other embodiments, the thermal reflective agent is selected from titanium dioxide, potassium hexatitanate, zirconium dioxide, zinc oxide, cadmium stannate, iron oxide, silicon carbide, or any combination thereof.

In accordance with a second aspect of the present invention, the present invention provides a lightweight thermal insulating cellular cement-based board. The lightweight thermal insulating cellular cement-based board is formed from a mixture composing of 100 parts by weight of a binder, 30-80 parts by weight of activator and 0.1-2 parts by weight of blowing agent. The lightweight thermal insulating cellular cement-based board has a thermal conductivity less than 0.08 W/mK, a density ranging between 300 and 1200 kg/m³ and a shrinkage smaller than 5% at 1200° C. It is worth noting that the lightweight thermal insulating cellular cement-based board has an integrity fire resistance rating for 4 hours and an insulation fire resistance rating for 4 hours.

In accordance with one embodiment of the present invention, the mixture further includes a filler in 0.1-20 parts by weight. In another embodiment, the mixture further includes a surfactant in 0.01-1 parts by weight.

In accordance with one embodiment of the present invention, the binder is selected from calcium aluminate cement, calcium sulfoaluminate cement, calcium sulfate cement, or a combination thereof.

In accordance with one embodiment of the present invention, the activator includes water, sodium hydroxide, potassium hydroxide, sodium silicate, potassium silicate, phosphoric acid, aluminium dihydrogen phosphate, or any combination thereof.

In accordance with one embodiment of the present invention, the blowing agent is selected from ammonium bicarbonate, sodium bicarbonate, hydrogen peroxide, C₄-C₇ aliphatic hydrocarbon, or any combination thereof.

In accordance with another embodiment of the present invention, the lightweight thermal insulating cellular cement-based board further has a thermal insulation layer disposed on it, and the thermal insulation layer includes a coating binder, an acid source, a carbon source, a coating blowing agent, and a thermal reflective agent.

In accordance with one embodiment of the present invention, the coating binder is selected from epoxy resin, acrylic emulsion, silicone emulsion, silicone-acrylic emulsion, styrene-acrylic emulsion, polyvinyl acetate emulsion, vinyl acetate-ethylene emulsion, sodium silicate solution, or any combination thereof.

In accordance with one embodiment of the present invention, the acid source is selected from ammonium polyphosphate, ammonium dihydrogen phosphate, ammonium hydrogen phosphate, melamine phosphates, melamine polyphosphate, melamine pyrophosphate, guanyl urea phosphate, urea phosphate, ammonium tetraborate or any combination thereof.

In accordance with another embodiment of the present invention, the carbon source is selected from pentaerythritol, dipentaerythritol, polyols, carbohydrates, or any combination thereof.

In accordance with one embodiment of the present invention, the coating blowing agent is selected from melamine, dicyandiamide, urea, glycine, guanidine, melamine cyanurate, melamine phosphate, melamine pyrophosphate, melamine polyphosphate, or any combination thereof.

In accordance with another embodiment of the present invention, the thermal reflective agent is selected from the group consisting of titanium dioxide, potassium hexatitanate, zirconium dioxide, zinc oxide, cadmium stannate, iron oxide, silicon carbide, or any combination thereof.

In accordance with one embodiment of the present invention, the lightweight thermal insulating cellular cement-based board is coated with a waterproofing agent or a weather-resistant coating to enhance its durability and resistance to environmental conditions.

In accordance with one embodiment of the present invention, the lightweight thermal insulating cellular cement-based board is incorporated into a sandwich panel configuration, with layers of different materials surrounding the cellular cement-based material, further enhancing its thermal insulating capabilities.

In accordance with a third aspect of the present invention, the present invention provides a modular integrated construction made of the lightweight thermal insulating cellular cement-based board.

### BRIEF DESCRIPTION OF THE DRAWINGS

Embodiments of the invention are described in more details hereinafter with reference to the drawings, in which:

FIG. 1 depicts the standard temperature/time curve of the standard fire condition specified in BS476-20;

FIG. 2 depicts the fire resistance of the lightweight thermal insulating cellular cement-based board under B S476-22 standard test;

FIGS. 3A-3B show the appearance of the lightweight thermal insulating cellular cement-based board before and after heating; FIG. 3A shows the appearance of the lightweight thermal insulating cellular cement-based board before the heating, and FIG. 3B. shows the appearance of the lightweight thermal insulating cellular cement-based board after the heating at 1200° C.; and

FIGS. 4A-4B depict the appearance of the lightweight thermal insulating cellular cement-based board Example C5; FIG. 4A show the cross-sectional area of Example C5 with water droplets, and FIG. 4B shows another view of the surface of Example C5 with water droplets added.

### DETAILED DESCRIPTION

In the following description, methods of manufacturing a lightweight thermal insulating cellular cement-based material and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention discloses a method of manufacturing a lightweight thermal insulating cellular cement-based material. The process involves activating a mixture comprising a binder, an activator, and a blowing agent, all initially in an inactive state, by increasing the temperature of the mixture. The mixture is subjected to homogenization to generate a cement slurry. Once the cement slurry is formed, it is subsequently poured into a mold under an increased temperature for activation. Within the mold, a unique combination of foaming and curing takes place simultaneously. The blowing agent and an increased temperature promote foaming and curing, respectively, resulting in the formation of a cellular cement-based material. During this process, the blowing agent decomposes, creating multiple closed-cell bubbles within the cement matrix. The simultaneous curing of the cement at an elevated temperature ensures that these bubbles are permanently fixed in place, forming a distinct cellular structure within the material.

The method starts with the preparation of the mixture, which includes carefully balanced amounts of a binder, an activator, and a blowing agent. The binder may be selected from a group of cementitious materials, such as calcium aluminate cement, calcium sulfoaluminate cement, calcium sulfate cement, or any combination thereof. The activator is chosen from a list that includes water, sodium hydroxide, potassium hydroxide, sodium silicate, potassium silicate, phosphoric acid, aluminium dihydrogen phosphate, or any combination thereof. The blowing agent is selected from the group consisting of ammonium bicarbonate, sodium bicarbonate, hydrogen peroxide, C₄-C₇ aliphatic hydrocarbon, or any combination thereof.

The mixture is homogenized to form a cement slurry. Subsequently, the cement slurry is carefully poured into a mold with an increased temperature to initiate the activation process, where the crucial foaming and curing processes occur simultaneously. This is achieved through the presence of the activator, which accelerates the cement curing, and the application of an elevated temperature in the mold. As a result, the blowing agent decomposes, generating multiple closed-cell bubbles within the cement matrix. The curing process at the elevated temperature ensures that these bubbles are permanently fixed in place, forming a unique cellular structure within the material. The use of in-situ foaming and curing to “lock in” the closed-cell structure, permits the commercial-scale formation of a low-density cement-based board.

The cellular cement-based material is then removed from the mold and possesses exceptional properties. The material boasts a thermal conductivity less than 0.08 W/mK, making it an excellent thermal insulator. Moreover, the material's density ranges between 300 and 1200 kg/m³, ensuring its lightweight nature. At extremely high temperatures of up to 1200° C., the material experiences minimal shrinkage, making it highly stable in extreme thermal conditions. Additionally, the material demonstrates outstanding fire resistance, with an integrity fire resistance rating for 4 hours and an insulation fire resistance rating for 4 hours.

The invention further offers the possibility of customizing the material for specific applications. The mixture may include additional components such as fillers or surfactants to enhance certain characteristics. Furthermore, the resulting cellular cement-based material may be cut, trimmed, or sanded into various specified shapes, such as blocks, panels, boards, or sheets, making it versatile for different construction and insulation purposes.

In some embodiments, after the foaming and curing processes, a thermal insulation layer can be applied to the cellular cement-based material. This is achieved by mixing a coating binder, an acid source, a carbon source, a coating blowing agent, and a thermal reflective agent to form a thermal insulation mixture. The thermal insulation mixture is then applied to the cellular cement-based material and cured, resulting in an additional layer that enhances the thermal insulating capabilities of the material.

The coating binder may be chosen from epoxy resin, acrylic emulsion, silicone emulsion, silicone-acrylic emulsion, styrene-acrylic emulsion, polyvinyl acetate emulsion, vinyl acetate-ethylene emulsion, sodium silicate solution, or any combination thereof. The acid source may include ammonium polyphosphate, ammonium dihydrogen phosphate, ammonium hydrogen phosphate, melamine phosphates, melamine polyphosphate, melamine pyrophosphate, guanyl urea phosphate, urea phosphate, ammonium tetraborate, or any combination thereof. The carbon source may include pentaerythritol, dipentaerythritol, polyols, carbohydrates, or any combination thereof. The coating blowing agent may be selected from melamine, dicyandiamide, urea, glycine, guanidine, melamine cyanurate, melamine phosphate, melamine pyrophosphate, melamine polyphosphate, or any combination thereof. Lastly, the thermal reflective agent may include titanium dioxide, potassium hexatitanate, zirconium dioxide, zinc oxide, cadmium stannate, iron oxide, silicon carbide, or any combination thereof.

The method of manufacturing the lightweight thermal insulating cellular cement-based material disclosed herein represents a significant advancement in the field of thermal insulation materials. The combination of a unique activation process, simultaneous foaming and curing, and the formation of closed-cell bubbles within the cement matrix results in a material with exceptional thermal insulation, low density, and remarkable fire resistance. The ability to customize the material for specific applications further enhances its versatility and utility.

The present invention also relates to a lightweight thermal insulating cellular cement-based board with exceptional thermal insulation, low density, and remarkable fire resistance. The board is formed from a unique mixture comprising specific proportions of a binder, an activator, and a blowing agent. The lightweight thermal insulating cellular cement-based board exhibits outstanding thermal insulation, density, and shrinkage characteristics, making it ideal for various applications in construction and insulation. Specifically, the mixture may have 100-200 parts by weight of a binder, 30-160 parts by weight of an activator and 0.1-4 parts by weight of a blowing agent.

The primary components of the mixture include a binder, an activator, and a blowing agent. The binder is selected from a group of cementitious materials, such as calcium aluminate cement, calcium sulfoaluminate cement, calcium sulfate cement, or any combination thereof. The activator is chosen from a list that includes water, sodium hydroxide, potassium hydroxide, sodium silicate, potassium silicate, phosphoric acid, aluminium dihydrogen phosphate, or any combination thereof. The blowing agent is selected from the group consisting of ammonium bicarbonate, sodium bicarbonate, hydrogen peroxide, C₄-C₇ aliphatic hydrocarbon, or any combination thereof.

The resulting lightweight thermal insulating cellular cement-based board possesses remarkable characteristics. Its thermal conductivity is less than 0.08 W/mK, indicating superior thermal insulation capabilities. The board's density ranges between 300 and 1200 kg/m³, ensuring its lightweight nature. At extremely high temperatures of up to 1200° C., the board exhibits minimal shrinkage, making it highly stable in extreme thermal conditions. Furthermore, the board demonstrates outstanding fire resistance, with an integrity fire resistance rating for 4 hours and an insulation fire resistance rating for 4 hours.

Particularly preferred density ranges between 300 and 600 kg/m³ with shrinkage less than 4% or less than 3% and thermal conductivity less than 0.06 W/mK. In one embodiment, the lightweight thermal insulating cellular cement-based board has a thermal conductivity of 0.04-0.06 W/mK, a density around 390-440 kg/m³, and a shrinkage less than 3%.

In some embodiments, additional components can be introduced to the mixture to enhance specific characteristics. The mixture may include fillers to further modify the board's properties, and surfactants to improve its processing and performance.

The filler may be a particulate filler such as sand, silica, kaolin, metakaolin, bentonite, muscovite, phlogopite, montmorillonite, talc, wollastonite, sepiolite, diatomaceous earth, perlite, vermiculite, TiO₂, or CaCO₃ or may be a fiber-based filler such as polypropylene fibers, glass fibers, or carbon fibers in an amount from approximately 0.1-20 parts by weight. The surfactant includes, cetyltrimethylammonium bromide, cetyltrimethylammonium chloride, cocamidopropylamine oxide, cocamidopropyl betaine, protein foaming agent, polyoxyethylene alkyl ethers (e.g. AEO-9, Triton X-100, Brij-30, Brij-52, Brij-58). In one embodiment, the surfactant may be an anionic surfactant such as alpha-olefin sulfonate (AOS), sodium dodecyl sulfate (SDS) or sodium dodecylbenzenesulfonate (SDBS). The amount of the surfactant may be in an amount of approximately 0.01-1 parts by weight.

Moreover, the lightweight thermal insulating cellular cement-based board can be further enhanced with a thermal insulation layer. This layer can be applied on top of the cellular cement-based board and includes a coating binder, an acid source, a carbon source, a coating blowing agent, and a thermal reflective agent. The thermal insulation layer is cured to form an additional coating that enhances the thermal insulating capabilities of the board.

The coating binder can be selected from a variety of options, including epoxy resin, acrylic emulsion, silicone emulsion, silicone-acrylic emulsion, styrene-acrylic emulsion, polyvinyl acetate emulsion, vinyl acetate-ethylene emulsion, sodium silicate solution, or any combination thereof. The acid source may include ammonium polyphosphate, ammonium dihydrogen phosphate, ammonium hydrogen phosphate, melamine phosphates, melamine polyphosphate, melamine pyrophosphate, guanyl urea phosphate, urea phosphate, ammonium tetraborate, or any combination thereof. The carbon source may include pentaerythritol, dipentaerythritol, polyols, carbohydrates, or any combination thereof. The coating blowing agent can be selected from melamine, dicyandiamide, urea, glycine, guanidine, melamine cyanurate, melamine phosphate, melamine pyrophosphate, melamine polyphosphate, or any combination thereof. Lastly, the thermal reflective agent may include titanium dioxide, potassium hexatitanate, zirconium dioxide, zinc oxide, cadmium stannate, iron oxide, silicon carbide, or any combination thereof.

To enhance the durability and resistance of the lightweight thermal insulating cellular cement-based board to environmental conditions, it can be coated with a waterproofing agent or a weather-resistant coating.

The board's versatile properties make it suitable for incorporation into various constructions, and it can be integrated into a sandwich panel configuration. The board serves as the core material, surrounded by different layers of materials, further enhancing its thermal insulating capabilities in a modular integrated construction.

In conclusion, the lightweight thermal insulating cellular cement-based board described herein offers a novel and effective solution for advanced thermal insulation needs. Its exceptional thermal insulation, low density, and remarkable fire resistance make it a desirable choice for numerous applications across various industries. The incorporation of additional components and the option for further enhancement through thermal insulation layers provide flexibility and adaptability to different requirements, ensuring its widespread utility and contributing to advancements in thermal insulation technology.

Below, particular examples of compositions are set forth that may be used to form the cement boards of the present invention. These compositions are set forth to show particular combinations of ingredients, however, it is understood that the full range and combination of ingredients as set forth above may be used in the present invention.

In one embodiment, the cement slurry C1 includes the binder, calcium aluminate cement, the activator, water, and the blowing agent, H₂O₂, and further includes a filler, CaCO₃. The components of cement slurry C1 is shown in Table 1.

TABLE 1

| Component | Parts by weight |
|---|---|
| Calcium aluminate cement | 120 |
| Water | 76.8 |
| H₂O₂ | 3.2 |
| CaCO₃ | 8.0 |

The cement slurry C1 is poured into a mold and then the mold is cured at 60° C. for 16 hours. After curing, the mold is removed to obtain the lightweight thermal insulating cellular cement-based material C1 with density of 386 kg/m³ and thermal conductivity of 0.050 W/mK.

In the other embodiment, the cement slurry C2 includes the binder, calcium aluminate cement, the activator, water, and the blowing agent, H₂O₂, and further includes a surfactant, cocamidopropylamine oxide. The component of cement slurry C2 is shown in Table 2.

TABLE 2

| Component | Parts by weight |
|---|---|
| Calcium aluminate cement | 120 |
| Water | 75.2 |
| H₂O₂ | 3.2 |
| Cocamidopropyl amine oxide | 1.6 |

The cement slurry C2 is poured into a mold, and then the mold is cured at 60° C. for 16 hours. After curing, the mold is removed to obtain the lightweight thermal insulating cellular cement-based material C2 with density of 358 kg/m³ and thermal conductivity of 0.044 W/mK.

In another embodiment, the cement slurry C3 includes the binder, calcium aluminate cement, the activator, water, and the blowing agent, H₂O₂, and further includes a surfactant, SDS, in different component weight percentages. The component of cement slurry C3 is shown in Table 3.

TABLE 3

| Component | Parts by weight |
|---|---|
| Calcium aluminate cement | 120 |
| Water | 78 |
| H₂O₂ | 1.6 |
| SDS | 0.4 |

The cement slurry C3 is poured into a mold, and then the mold is cured at 70° C. for 16 hours. After curing, the mold is removed to obtain the lightweight thermal insulating cellular cement-based material C3 with density of 745 kg/m³ and thermal conductivity of 0.073 W/mK. As a result, C3 has a lower porosity.

In one embodiment, the cement slurry C4 includes the binder, calcium aluminate cement, the activator, water, and the blowing agent, H₂O₂, and further includes a surfactant, SDS, and an additive, muscovite. The component of cement slurry C4 is shown in Table 4.

TABLE 4

| Component | Parts by weight |
|---|---|
| Calcium aluminate cement | 150 |
| Water | 95 |
| H₂O₂ | 4 |
| SDS | 1 |
| Muscovite | 1.5 |

The cement slurry C4 is poured into a mold, and then the mold is cured at 70° C. for 16 hours. After curing, the mold is removed to obtain the lightweight thermal insulating cellular cement-based material C₄ with density of 432 kg/m³ and thermal conductivity of 0.040 W/mK.

In another embodiment, the cement slurry C5 includes the binder, calcium aluminate cement, the activator, water, and the blowing agent, H₂O₂, and further includes a filler, CaCO₃, a surfactant, SDS, and several additives such as DMS-S15, MTMS and DBTDA. The component of cement slurry C5 is shown in Table 5.

TABLE 5

| Component | Parts by weight |
|---|---|
| Calcium aluminate cement | 150 |
| Water | 95 |
| H₂O₂ | 4 |
| SDS | 1 |
| CaCO₃ | 1.5 |
| DMS-S15 | 0.75 |
| MTMS | 0.075 |
| DBTDA | 0.0075 |

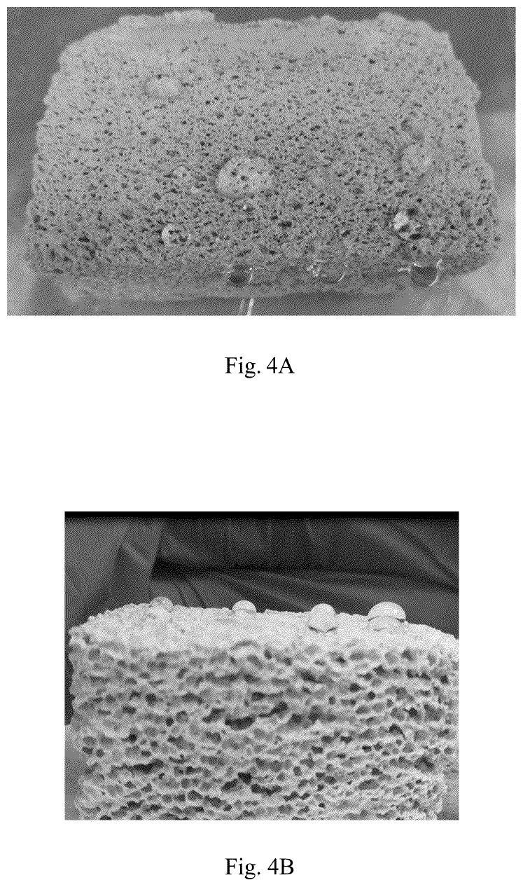

The cement slurry C5 is poured into a mold, and then the mold is cured at 70° C. for 16 hours. After curing, the mold is removed to obtain the lightweight thermal insulating cellular cement-based material C5 with density of 365 kg/m³ and thermal conductivity of 0.040 W/mK. C5 has hydrophobic surfaces. As shown in FIG. 4A, the cross-sectional area of material C5 has hydrophobic surfaces that can keep water droplets on the surface without soaking. Referring to FIG. 4B, it shows a horizontal view of Example C5 exhibiting the hydrophobic feature of the material C5.

In accordance with another aspect of the present invention, the lightweight thermal insulating cellular cement-based material further includes a thermal insulation coating.

In one embodiment, the cement slurry is composed of calcium aluminate cement, water, H₂O₂, SDS and TiO₂. The parts by weight of each ingredient are shown in Table 6.

TABLE 6

| Component | Parts by weight |
|---|---|
| Calcium aluminate cement | 150 |
| Water | 94.5 |
| H₂O₂ | 4 |
| SDS | 1.5 |
| TiO₂ | 3.75 |

The cement slurry is poured into a mold, and then the mold is cured at 70° C. for 16 hours. After curing, the mold is removed to obtain the lightweight thermal insulating cellular cement-based material. Subsequently, preparing a microporous thermal insulation coating with a component listed in Table 7. And applying the coating mixture evenly on the lightweight thermal insulating cellular cement-based material to generate a thermal insulation layer on the surface.

TABLE 7

| Component | Parts by weight |
|---|---|
| Silicone resin emulsion | 150 |
| Water | 40 |
| Ammonium polyphosphate | 60 |
| Pentaerythritol | 20 |
| Melamine | 20 |
| CaCO₃ | 5 |
| SiO₂ | 5 |
| TiO₂ | 5 |
| Al(OH)₃ | 5 |

In another embodiment, the cement slurry is composed of calcium aluminate cement, water, H₂O₂, SDS and TiO₂. The parts by weight of each ingredient are shown in Table 8.

TABLE 8

| Component | Parts by weight |
|---|---|
| Calcium aluminate cement | 150 |
| Water | 94.5 |
| H₂O₂ | 4 |
| SDS | 1.5 |
| TiO₂ | 3.75 |

The cement slurry is poured into a mold, and then the mold is cured at 70° C. for 16 hours. After curing, the mold is removed to obtain the lightweight thermal insulating cellular cement-based material. Subsequently, preparing a microporous thermal insulation coating base coat and top coat with components listed in Table 9 and 10. The base coat provides thermal insulation and acts as a primer of the lightweight thermal insulating cellular cement-based material. The top coat acts as a reactive coating that expands at high temperature for additional insulation. And applying the coating mixture evenly on the lightweight thermal insulating cellular cement-based material to generate a thermal insulation layer on the top of it.

TABLE 9
Preparation of microporous thermal insulation coating base coat

| Component | Parts by weight |
|---|---|
| Ethylene-vinyl acetate emulsion | 160 |
| Water | 80 |
| Cenospheres | 80 |
| Hollow glass microspheres | 20 |
| TiO₂ | 32 |

TABLE 10
Preparation of microporous thermal insulation coating top coat

| Component | Parts by weight |
|---|---|
| Silicone resin emulsion | 150 |
| Water | 40 |
| Ammonium polyphosphate | 60 |
| Pentaerythritol | 20 |
| Melamine | 20 |
| AlPO₄ | 20 |
| Cenospheres | 10 |

The binder can be 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79% or 80% by weight or other incremental percentage between.

The activator can be 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% by weight or other incremental percentage between.

The blowing agent can be 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9% or 2% by weight or other incremental percentage between.

The filler can be 0%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2%, 3%, 4%, 5%, 6%, 7%, 8%, 9%, 10%, 11%, 12%, 13%, 14%, 15%, 16%, 17%, 18%, 19% or 20% by weight or other incremental percentage between.

The surfactant can be 0%, 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, or 1.0% by weight or other incremental percentage between.

In accordance with a second aspect of the present invention, a lightweight thermal insulating cellular cement-based board is provided.

The cement slurry components are mixed using an electric mixer at low speed for 1 minute, or until the solids are thoroughly wetted by the liquid, then at medium speed for 5 minutes, or until a smooth slurry without lumps. A cement slurry is thus obtained. Excessive mixing speed and duration should be avoided to maintain the viscosity and stability of the cement slurry.

The cement slurry is poured into mold of non-limiting shapes and sizes, including prism-shaped, for example, square prism-, rectangular prism-, and cylindrical-shaped mold.

The mold filled with cement slurry is placed in an oven at elevated temperature for 16 h for simultaneous foaming and curing. The temperature can be optimally adjusted based on the type of binder. For example, if the binder is calcium aluminate cement, the best temperature is 60-80° C., and the upper limit of the temperature depends on the boiling point of the activator. Furthermore, the curing time is also adjustable for increasing production rate, for example, the curing time is around 2-4 h.

The top of the mold is covered during the process to retain moisture level of the cement slurry during the process. This step is optional if the humidity of the oven is controlled.

### EXAMPLES

### Example 1

For characterizing fire resistance performance of the invention, the lightweight thermal insulating cellular cement-based material is subjected to a fire condition defined in BS476-20, as follows:

T=345 log₁₀(8t+1)+20.

Briefly, the “T” stands for the mean furnace temperature (° C.) and the “t” is the time (min) up to a maximum of 360 mins. As shown in FIG. 1, the standard temperature/time curve of the furnace is depicted based on the formula. The standard temperature of the furnace at selected time points is shown in Table 11.

TABLE 11
Standard temperature/time curve

| Time | Furnace |
|---|---|
| (min) | temperature (° C.) |
| 0 | 20 |
| 5 | 576 |
| 10 | 678 |
| 15 | 738 |
| 20 | 781 |
| 30 | 842 |
| 45 | 902 |
| 60 | 945 |
| 90 | 1006 |
| 120 | 1049 |
| 150 | 1082 |
| 180 | 1110 |
| 210 | 1133 |
| 240 | 1153 |
| 300 | 1186 |
| 360 | 1214 |

### Example 2

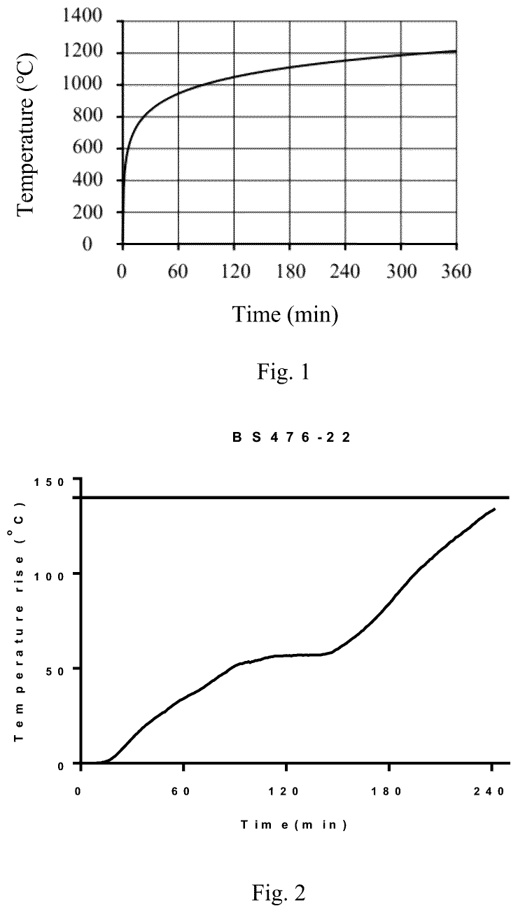

Referring to FIG. 2, BS476-22 standard test, method for determination of the fire resistance of non-loadbearing elements of construction, is conducted to evaluate the fire resistance of the lightweight thermal insulating cellular cement-based board. The lightweight thermal insulating cellular cement-based boards are mounted onto a wall installed onto the specimen support frame of the furnace, which are subjected to the standard fire condition specified in BS476-20 for 4 hours. It is shown that the temperature of the unexposed surface board of present invention is less than 140° C. The board of present invention shows an integrity rating of 4 hours with an insulation rating of 4 hours.

### Example 3

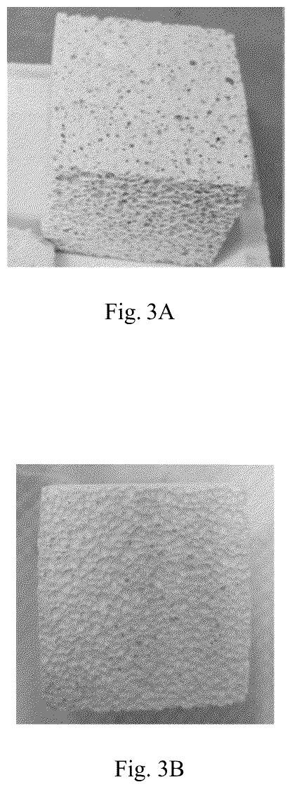

Referring to FIGS. 3A-3B, the lightweight thermal insulating cellular cement-based material is subjected to be heated at 1200° C. for 4 hours. Before the heating, the lightweight thermal insulating cellular cement-based material is shaped as a block (FIG. 3A). After the high temperature process, the lightweight thermal insulating cellular cement-based material remains intact (FIG. 3B). There is no burst, perforation, crack or any damage. The results suggest that the lightweight thermal insulating cellular cement-based material has a great fire resistance and low shrinkage.

Thermal conductivity is measured by C-Therm TCi Thermal conductivity analyzer that conforms to the standard test method ASTM D7984.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A method of manufacturing a lightweight thermal insulating cellular cement-based material, comprising:
providing a mixture comprising a binder, an activator, and a blowing agent, wherein the binder, the activator and the blowing agent are in an inactive state;
homogenizing the mixture to form a cement slurry;
pouring the cement slurry into a mold;
activating the cement slurry to undergo a foaming and a curing simultaneously through the blowing agent and an increased temperature in the mold to form a cellular cement-based material, wherein the blowing agent decomposes to form a plurality of closed-cell bubbles that are fixed by the simultaneous curing of the cement at an increased temperature; and
removing the cellular cement-based material from the mold, wherein the lightweight thermal insulating cellular cement-based material has a thermal conductivity less than 0.08 W/mK, a density ranging between 300 and 1200 kg/m³ and a shrinkage smaller than 5% at 1200° C. and an integrity fire resistance rating for 4 hours and an insulation fire resistance rating for 4 hours.

2. The method of claim 1, wherein the blowing agent is selected from the group consisting of ammonium bicarbonate, sodium bicarbonate, hydrogen peroxide, C₄-C₇ aliphatic hydrocarbon, or any combination thereof.

3. The method of claim 1, wherein the binder is selected from the group consisting of calcium aluminate cement, calcium sulfoaluminate cement, calcium sulfate cement, or any combination thereof.

4. The method of claim 1, wherein the activator comprises water, sodium hydroxide, potassium hydroxide, sodium silicate, potassium silicate, phosphoric acid, aluminium dihydrogen phosphate, or any combination thereof.

5. The method of claim 1, wherein the mixture further comprises a filler.

6. The method of claim 1, wherein the mixture further comprises a surfactant.

7. The method of claim 1, further comprising cutting, trimming or sanding the cement-based material into a specified shape, wherein the specified shape comprises a block, a panel, a board or a sheet.

8. The method of claim 1, after effecting the foaming and the curing to the cement slurry simultaneously through the blowing agent and an increased temperature further comprising:
mixing a coating binder, an acid source, a carbon source, a coating blowing agent, and a thermal reflective agent to form a thermal insulation mixture;
applying the thermal insulation mixture to the cellular cement-based material; and
curing the thermal insulation mixture to form a thermal insulation layer on the cellular cement-based material.

9. The method of claim 8, wherein the coating binder is selected from the group consisting of epoxy resin, acrylic emulsion, silicone emulsion, silicone-acrylic emulsion, styrene-acrylic emulsion, polyvinyl acetate emulsion, vinyl acetate-ethylene emulsion, sodium silicate solution, or any combination thereof.

10. The method of claim 8, wherein the acid source is selected from the group consisting of ammonium polyphosphate, ammonium dihydrogen phosphate, ammonium hydrogen phosphate, melamine phosphates, melamine polyphosphate, melamine pyrophosphate, guanyl urea phosphate, urea phosphate, ammonium tetraborate or any combination thereof.

11. The method of claim 8, wherein the carbon source is selected from the group consisting of pentaerythritol, dipentaerythritol, polyols, carbohydrates, or any combination thereof.

12. The method of claim 8, wherein the coating blowing agent is selected from the group consisting of melamine, dicyandiamide, urea, glycine, guanidine, melamine cyanurate, melamine phosphate, melamine pyrophosphate, melamine polyphosphate, or any combination thereof.

13. The method of claim 8, wherein the thermal reflective agent is selected from the group consisting of titanium dioxide, potassium hexatitanate, zirconium dioxide, zinc oxide, cadmium stannate, iron oxide, silicon carbide, or any combination thereof.

14. A lightweight thermal insulating cellular cement-based board formed from a mixture comprising:
100 parts by weight of a binder;
30-80 parts by weight of an activator to accelerate cement-based board curing by increasing a slurry temperature; and
0.1-2 parts by weight of a blowing agent;
wherein a combination of the blowing agent and the activator are selected such that foaming curing a cement slurry occurs simultaneously to form the cement-based board, the blowing agent decomposing to form a plurality of closed-cell bubbles that are fixed by the simultaneous curing of the cement-based board at an increased temperature from the activator; and
wherein the lightweight thermal insulating cellular cement-based board has a thermal conductivity less than 0.08 W/mK, a density ranging between 300 and 1200 kg/m³ and a shrinkage smaller than 5% at 1200° C.; wherein the lightweight thermal insulating cellular cement-based board has an integrity fire resistance rating for 4 hours and an insulation fire resistance rating for 4 hours.

15. The lightweight thermal insulating cellular cement-based board of claim 14, wherein the mixture further comprising a filler, wherein the filler is 0.1-20 parts by weight in the cellular fireproof cement-based board.

16. The lightweight thermal insulating cellular cement-based board of claim 14, wherein the mixture further comprising a surfactant, wherein the surfactant is 0.01-1 parts by weight in the cellular fireproof cement board.

17. The lightweight thermal insulating cellular cement-based board of claim 14, wherein the binder is selected from the group consisting of calcium aluminate cement, calcium sulfoaluminate cement, calcium sulfate cement, or a combination thereof.

18. The lightweight thermal insulating cellular cement-based board of claim 14, wherein the activator comprises water, sodium hydroxide, potassium hydroxide, sodium silicate, potassium silicate, phosphoric acid, aluminium dihydrogen phosphate, or any combination thereof.

19. The lightweight thermal insulating cellular cement-based board of claim 14, wherein the blowing agent is selected from the group consisting of ammonium bicarbonate, sodium bicarbonate, hydrogen peroxide, C₄-C₇ aliphatic hydrocarbon, or any combination thereof.

20. The lightweight thermal insulating cellular cement-based board of claim 14, further comprising:
a thermal insulation layer disposed on the lightweight thermal insulating cellular cement-based board, wherein the thermal insulation layer includes a coating binder, an acid source, a carbon source, a coating blowing agent, and a thermal reflective agent.

21. The lightweight thermal insulating cellular cement-based board of claim 20, wherein the coating binder is selected from the group consisting of epoxy resin, acrylic emulsion, silicone emulsion, silicone-acrylic emulsion, styrene-acrylic emulsion, polyvinyl acetate emulsion, vinyl acetate-ethylene emulsion, sodium silicate solution, or any combination thereof.

22. The lightweight thermal insulating cellular cement-based board of claim 20, wherein the acid source is selected from the group consisting of ammonium polyphosphate, ammonium dihydrogen phosphate, ammonium hydrogen phosphate, melamine phosphates, melamine polyphosphate, melamine pyrophosphate, guanyl urea phosphate, urea phosphate, ammonium tetraborate or any combination thereof.

23. The lightweight thermal insulating cellular cement-based board of claim 20, wherein the carbon source is selected from the group consisting of pentaerythritol, dipentaerythritol, polyols, carbohydrates, or any combination thereof.

24. The lightweight thermal insulating cellular cement-based board of claim 20, wherein the coating blowing agent is selected from the group consisting of melamine, dicyandiamide, urea, glycine, guanidine, melamine cyanurate, melamine phosphate, melamine pyrophosphate, melamine polyphosphate, or any combination thereof.

25. The lightweight thermal insulating cellular cement-based board of claim 20, wherein the thermal reflective agent is selected from the group consisting of titanium dioxide, potassium hexatitanate, zirconium dioxide, zinc oxide, cadmium stannate, iron oxide, silicon carbide, or any combination thereof.

26. The lightweight thermal insulating cellular cement-based board of claim 14, wherein the lightweight thermal insulating cellular cement-based board is coated with a waterproofing agent or a weather-resistant coating to enhance its durability and resistance to environmental conditions.

27. The lightweight thermal insulating cellular cement-based board of claim 14, wherein the lightweight thermal insulating cellular cement-based board is incorporated into a sandwich panel configuration, with layers of different materials surrounding the cellular cement-based material, further enhancing its thermal insulating capabilities.

28. A modular integrated construction made of the lightweight thermal insulating cellular cement-based board of claim 14.
